(19) United States
(12) Patent Application Publication
(10) Pub. No.: US 2008/0210315 A1
(43) Pub. Date: Sep. 4, 2008

(54) MULTI-WATER FILTER AND FAUCET SYSTEM

(76) Inventor: Dana Harrison, Santa Barbara, CA (US)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/041,661

(22) Filed: Mar. 3, 2008

Related U.S. Application Data
(60) Provisional application No. 60/892,745, filed on Mar. 2, 2007.

(51) Int. Cl. B67D 5/58; B67D 5/32; F16K 37/00; F16K 11/00; F17D 1/08

(52) U.S. Cl. 137/551; 137/625.4; 137/625.41; 222/144.5

(57) ABSTRACT

A plurality of water processing units are connected together, in sequence, to produce one processed water, and tap-off connections are installed within various interconnections between various water processing units, to produce a plurality of different processed waters. The different processed waters from the sequence of water processing units and the tap-off connections are input to a plurality of input ports of a water faucet, the faucet having a selectable mode valve for outputting a selectable one of the different processed waters. Optionally, a condition of the water processing is monitored by a data processor.

### CROSS-REFERENCE TO RELATED APPLICATIONS

This application claims priority to U.S. Provisional Application Ser. No. 60/892,745, filed Mar. 2, 2007, which is hereby incorporated by reference.

### TECHNICAL FIELD

This disclosure relates to water filters for installation and use in homes.

### BACKGROUND

Water filters are often installed in homes, for improving the potability, odor and taste of water from a faucet or spigot, and often employ a medium, such as carbon or the like. Home water filters are typically arranged in line with the water feed to a faucet or spigot, or may be attached to the end of a standard faucet, may be incorporated within a special faucet, or may be installed as a parallel unit with a separate outlet, e.g., spigot, adjacent a standard faucet.

Water filters for home installation and use can also include reverse osmosis (RO) water filters and ultraviolet (UV) treatment units, and these are typically assembled in a fixed, staged arrangement with a carbon or similar pre-filter, and installed in line with the water feed to the faucet, or outputting to a separate, dedicated outlet adjacent the standard faucet

Water filters for installation and use in or with home faucets are particularly configured, at time of manufacture or installation, to perform a given purifying operation, such as removing a specified list of materials, or kinds of materials that be considered impurities, contaminants, or simply undesired substances. For example, a particular home filter may be selected from a vendor catalog, or may be custom configured and constructed to remove chlorine, certain specified heavy metals, e.g., lead, particular pesticides, particular organic matter, particular herbicides, and fluoride.

### BRIEF DESCRIPTION OF THE DRAWINGS

FIG. 1 is a functional block diagram of one multi-water conditioning system having one multi-water faucet arrangement; and

FIG. 2 is a functional block diagram of one subscriber-type network-based multi-water conditioning system.

### DETAILED DESCRIPTION OF ILLUSTRATIVE EMBODIMENTS

The following detailed description refers to accompanying drawings that form part of this description. The drawings, though, show only illustrative examples of embodiments, and of arrangements and implementations for practicing the invention. Many alternative configurations and arrangements can, upon reading this description, be readily identified by persons skilled in the arts.

Like numerals appearing in different ones of the accompanying drawings, either of the same or of different embodiments, reference functional blocks or structures that are, or may be, identical or substantially identical between the different drawings.

In the figures, the relative size and various spacing between items and blocks is for the purpose of providing a visualization of example functions, thereby enabling persons of ordinary skill in the art to implement and construct various systems and alternative arrangements embodying the claimed invention and, unless otherwise stated or clear from the description, the items and blocks are not necessarily drawn to any scale representing any relative physical proportion or any relative degree of operational burden or functional importance.

It will be understood that even if different illustrative examples show, or are described as having different structures or arrangements, that the example structures and arrangements are not necessarily mutually exclusive. For example, one feature described in one disclosed example may, within the scope of the appended claims, be included in or used with other embodiments. Therefore, instances of the phrase “in one embodiment” do not necessarily refer to the same embodiment.

Unless otherwise stated or clear from their context in the description, various instances of terms describing spatial relation of structure(s), such as “over”, “around”, “above”, “adjacent”, “arranged on” and “provided on”, mean only the spatial relation of the structures referenced and, unless otherwise stated or made clear from the context, do not limit any sequence, type, or order of manufacturing or fabrication.

According to one embodiment, a water processing system has a plurality of water processing means, each generating water filtered or processed according to a given specification, each of the different processed waters input, via a particular flow path, to a corresponding one of a plurality of input ports of a multi-water faucet having a plurality of input ports, an output port, and a multi-position or multi-mode valve apparatus for selectively connecting any of the input ports to the output port.

With respect to the water processing means, each of the means conditions water according to particular process. The term “conditions” is defined as a specific change, supplementation or limit to any parameter, relating to any element, mixture of elements, chemical mixture, or gasses, with respect to being dissolved, suspended, or mixed in the water, according to any given specification. All filtering, supplementing or other process defining each different conditioning performed by each of the plurality of water conditioning means may, for example, be fixed at time of manufacture.

All references herein to a “water conditioning means” are in reference to a particular processing function, without limitation to structure, except in instances where otherwise stated. One illustrative example of “one water conditioning means” is a conventional carbon filter having one water port one water output port, a flow path from the input port to the output port, and a carbon medium within the water flow path.

As described in one or more examples, a water input port of one water conditioning means may receive, for example, municipal water, or may receive water from an output port of a water filter substructure within or implementing another water conditioning means.

Another illustrative example of a water conditioning means, in a system having a plurality of water conditioning means, may be a two-stage filter, having a first stage for removing, for example, particulate matter larger than a given first average diameter and a second stage connected to an output port of the first stage, for removing particulate matter larger than a given second average diameter, the second average diameter being smaller than the first average diameter.

Preferably all water conditioning means for practicing the embodiments employ any medium or other filtering process that is suitable for processing water toward potability.

As described herein, in at least one example implementation, one housing or canister may contain a plurality of water processing means. For example, according to one more embodiments, one housing may enclose three or more water processing means. In an example including a housing enclosing four water processing means, the housing may have one external water input port and may have four external water output ports, one output port for each of the four water processing means.

Further, in one implementation having within one housing a reverse-osmosis (“RO”) filter as one of the water conditioning means and also having another water conditioning means, either preceding or succeeding the RO filter, the one housing may include intermediate ports for connections to, for example, an external holding tank.

In one embodiment, a multi-water system includes a plurality of water conditioning means implemented as a sequential arrangement of filter or other processing stages, with various intermediate water tap-offs arranged in various water flow paths between the various stages.

According to one embodiment, one example sequential arrangement includes a first stage, a second stage and a third stage, with a first intermediate tap-off outlet interposed in a flow path between the first stage and the second stage, and a second intermediate tap-off outlet interposed in a water path between the second stage and the third stage. As will be readily understood upon reading this entire disclosure, this one three-stage example of a sequential arrangement is only illustrative, and the general arrangement is readily reducible to two stages and is readily expandable to, for example, four or more stages.

According to one embodiment, a plurality of different water processing means may be collectively embodied by a multi-stage sequential filter arrangement. As one illustrative example, in a sequential arrangement of a first stage and a second stage, one water processing means may be embodied by the water path established by the total path through the first stage and the second stage, with the output of the second stage connected to one input port of a multi-water faucet having a plurality of inputs ports, one output port, and a selectable multi-mode valve for connecting any one of the input ports to the output port. In the same illustrative example, another water processing means may be embodied by the first stage alone, combined with a flow path to another input of the multi-water faucet through, for example, a “T” connection between the first and second stage.

According to one embodiment having a plurality of different water processing means collectively embodied by a multi-stage sequential filter arrangement, each of the intermediate tap-off connections between different filters in the arrangement may be a “T” connection, having three ports, one of the ports being connected to the output of one of the filters, one of the ports connected to the input of another of the filters, and the third port connected to one of the inputs of the multi-port faucet. According to one embodiment, intermediate tap-off connections between different filters need not include any valve mechanism.

In one example, according to one embodiment, three water processing means may be collectively embodied by a three-stage filter arrangement, having a first stage, a second stage and a third stage, with a first intermediate tap-off outlet interposed between the first stage and the second stage, and a second intermediate tap-off outlet between the second stage and the third stage. According to one example implementation, the first intermediate tap off between a first stage and a second stage may concurrently provide two water flow paths, one flow path being from an output of the first stage to an input of the second stage, the other flow path from the output of the first stage to one of the inputs of the multi-water faucet.

Likewise, in one example according to one embodiment, a second intermediate tap off between a second stage and a third stage may concurrently provide two water flow paths, one water flow path being from an output of the second stage to an input of the third stage, the other water flow path from the output of the second stage to another of the inputs of the multi-water faucet.

According to one embodiment having, for example, three different water processing means embodied by a three-stage filter arrangement, the multi-water faucet may have three input ports, one output port, and a user-controllable valve that connects any of the three input ports to the output port.

In one example, a user-controllable valve within the multi-water faucet may have a rotating valve member within a valve body, constructed and arranged to align different ports and passages to selectively establish a water flow path from any of the different input ports to the output port, depending on a rotational angle of, for example, a rotatable handle. U.S. Pat. No. 6,196,266, which is hereby incorporated by reference, discloses one illustrative example of a multi-port valve having a rotating valve member. The multi-port valve disclosed by U.S. Pat. No. 6,196,266A is described in a single input-multiple output arrangement, but may be reversed with respect to flow direction, and installed within a faucet housing, to implement a multi-water faucet within a system according to this invention.

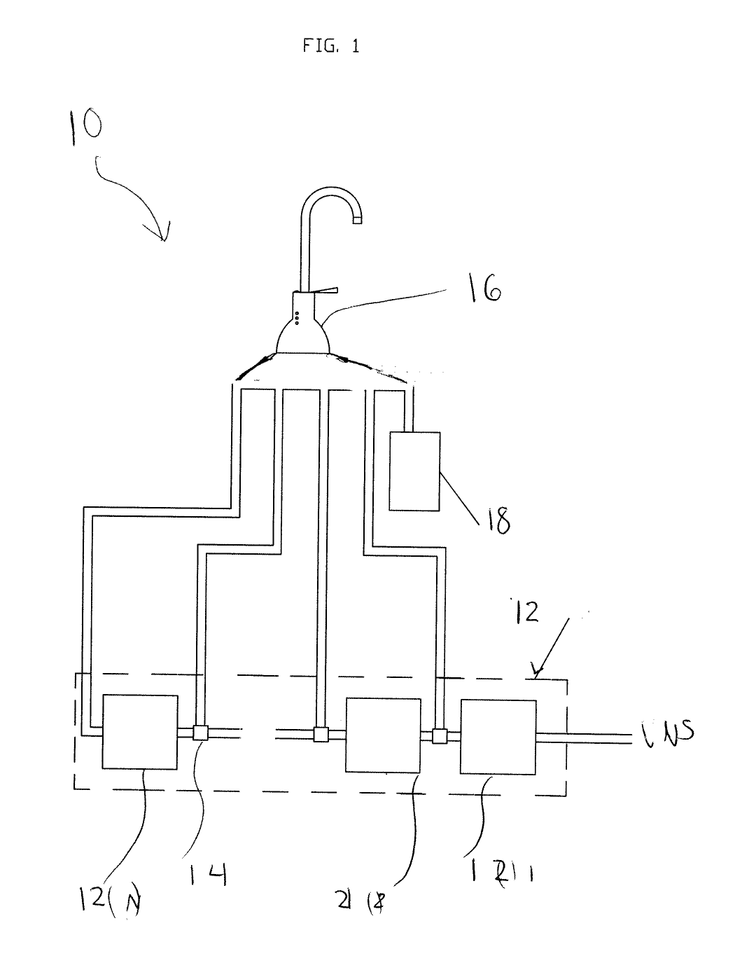

FIG. 1 shows one example multi-water system 10 having at least one embodiment of the invention. The example system 10 includes a plurality of particular water conditioning means, referenced collectively as 12 and individually as 12i, i=1 to N, where N is an arbitrary number, having respective outputs (not separately labeled) connecting to and received by a multi-water faucet 16. The multi-water faucet 16 has at least N input ports, one output port and includes at least one valve, which may be manually operated or moved by servo controlled actuators, for selectively connecting any of the N inputs to the output. For example, the one or more valves within the multi-water faucet 16 may be controlled by one manually rotatable knob or handle, or by multiple manually actuated levers. In one embodiment, a “no-touch controller may be incorporated into the multi-water faucet 16, operating in response to motion or sound.

Referring to FIG. 11, the multi-water faucet 16 may, for example, be constructed and arranged to include a plurality of valves (not shown in FIG. 1), controlled by manual pressing of pushbuttons, levers, a touch-pad, or other manual control interface (not shown in FIG. 1) such as, for example, a beverage gun as disclosed by U.S. Pat. Nos. 4,673,108, 4,921,140 and/or 7,028,864, each of which is hereby incorporated by reference, arranged within a fixedly mounted faucet type housing.

With continuing reference to FIG. 1, in addition to water conditioning means 12, the system 10 may also include a water flavoring unit 18 for adding, for example various flavors into the water for a desired flavor. The water flavoring unit 18 may include a single flavor reservoir or source, or any combination of multiple flavor reservoirs or sources. The water flavoring unit 18 may include a selection means (not shown in FIG. 1) for selecting from among multiple flavor, as will be described in detail.

The system 10 therefore may include multiple water conditioning means 12, water, flavoring unit 18 and means for selection and control of which water conditioning unit 12 is connected to output of the faucet. The selection of water conditioning means 12 and flavoring devices may be configured to suit any permutation of possible combinations to suit desired results.

Referring to FIG. 1, one implementation of the multi-water faucet 16 may include a bar gun such as, for example, disclosed by U.S. Pat. Nos. 4,673,108, 4,921,140 and/or 7,028,864, arranged within a fixedly mounted faucet type housing, arranged to have an arbitrary quantity of N+1 inputs, with up to N of the inputs connected to a respective N outputs of N water conditioning units 12, and one input connected to the output of a water flavoring unit 18. One example value of N is four.

With continuing reference to FIG. 1, an implementation of the water-flavoring unit 18 may include one flavor reservoir, holding any flavoring. An implementation of the water flavoring unit 18 may include a plurality of M flavor reservoirs, each holding a different flavor, each of the plurality connected to one of M different inputs of another multiple-input-single output valve arrangement such as, for example, the structure disclosed by any of U.S. Pat. Nos. 4,673,108, 4,921,140 and/or 7,028,864, modified to be controlled by the same button interface (not shown in FIG. 1) that controls a bar gun type implementation of the multi-water faucet 16.

According to one embodiment, various water system sensors may be included in a system such as, for example the system 10 of FIG. 1, and these sensors may connect via, for example, a wired or wireless network protocol to a data processor such as, for example, a programmable personal computer located on the premises having system 10, or a data processing resource remote from the system 10. Each water system sensor may include any sensor that detects any water condition, such as a parts-per-million concentration of a particular element or chemical, or any water flow condition such as, for example, pressure or flow rate.

For example, water system sensors may include sensors inserted into carbon medium filter stages, filtration devices to monitor flow rates or other characteristics, which would then transmit status information to a receiver. In another example, sensors may be attached to flavoring devices to monitor flavoring levels, which would then transmit status information to a receiver.

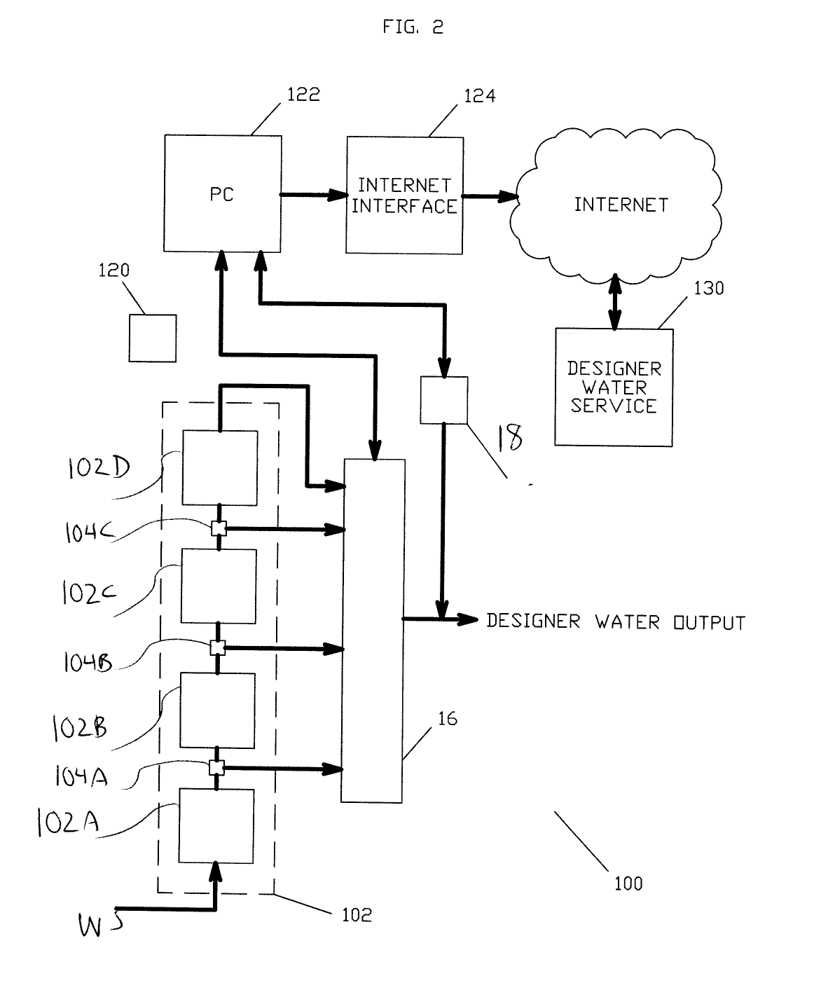

FIG. 2 shows one example system 100, having a plurality of four water conditioning units, referenced generally as 102, comprising a first water conditioning unit 102A, a second water conditioning unit 102B, a third water conditioning unit 102C, and a fourth water conditioning unit 102D. The fourth water conditioning unit 102C in the depicted system 100 may be an RO filter, having a holding tank (not separately numbered).

With continuing reference to FIG. 2, an external water source WS connects to an input port (not separately labeled) of the first water conditioning unit 102A. The external water source WS may, for example, be a municipal water supply, or may be an output from a local well pump. A first T-type tap-off 106A is arranged between the first water conditioning unit 102A and the second water conditioning unit 102B. A first water line 108A connects to one input (not separately numbered) of a four-to-one multi-water faucet 16, as described above.

Referring to FIG. 2, a second T-type tap-off 106A is arranged between the second water conditioning unit 102B and the third water conditioning unit 102C. A second water line 108B connects to one input (not separately numbered) of the four-to-one multi-water faucet 16. A third T-type tap-off 106C is arranged between the third water conditioning unit 102C and the input to the fourth water conditioning unit 102D. A third water line 108C connects to one input (not separately numbered) of the four-to-one multi-water faucet 16. The output of the fourth water conditioning unit 102D, which may be an output of a holding tank, connects, via a fourth water line 108D, to the fourth input of the multi-water faucet 16.

Referring to FIG. 2, a water flavor unit 18 may be connected to the data processing resource 122, for purposes of, for example, monitoring the level of flavoring or, as an additional feature of a multi-reservoir water flavoring unit 18, providing a custom mix of different flavors that is controllable from the data processing resource 122.

With continuing reference to FIG. 2, various water system sensors, generally referenced as 120, communicate to a data processing resource 122. The data processing resource 122 may be any computing device capable of performing user interface, storage, data communication and processing according to the described invention. The data processing resource 122 may, for example, be a self-contained computing device, or may be a typical off-the-shelf general purpose programmable personal or business computer having, for example, a local internal bus connecting a microprocessor, a local storage, an input/output device such as a keyboard, touch-screen and/or trackpad, a hard disc drive or other mass storage unit, and a display. A network interface such as, for example, the FIG. 2 Internet interface 124 may connect the data processing resource to the INtenet or to another type of network.

Referring to FIG. 2, the data processing resource 122 may be, or may include, a remote computer system such as, for example, a separate facility or centralized service provider, connected to the water system sensors over, for example, the Internet. The data processing resource 122 may accept transmitted information from the water system sensors 120, and may analyze and process the information to determine status of individual devices, as well as systems, with respect to performance, refills, failures, or routine maintenance scheduling.

In one embodiment, for example, the water system sensors 120 and data processing resource 122 provide a monitoring system that may detect conditions of the system 100 such as, for example, a sub-optimal flow rate from, or between, any of the water conditioning units 102, and transmit this information to the data processing resource 122. The data processing resource 122 may then process the information using, for example, a readily implemented software program having instructions that, for example, respond to particular warning signals sent by the water system sensors 120, or that continuously compare the signal values from the sensors 120 to programmed limits. The instructions may include notifying the local or remote computer system, which would then generate an e-mail or SMS text message to one or more pre-configured recipients to alert them of the condition, thereby allowing time to perform preventive maintenance or component replacement before the component might otherwise fail without prior warning.

With continuing reference to FIG. 2, the date processing resource 122 may connect the user to a subscriber-type service provider such as, for example a designer water service 130.

In one embodiment, for example, a monitoring system implemented by, for example, the sensors 120 and data processing resource 122 may detect that a flavoring device, such as 18, is low on flavor material (liquid or otherwise) and, in response, generate an e-mail or SMS alert to, for example, a service provider 130 to deliver a refill or replacement.

The software program within the data processing resource 122 may include instructions to take one action, or any action from a plurality of actions based upon, for example, the nature of the sensor information received. Example actions may comprise, for example, sending e-mail messages, SMS text messages, publishing to web sites, publishing to database systems, publishing to log files or logging services, placing telephone voice calls, signaling a visual indicator such as light or sign, generating an audible alert such as an alarm or bell sound, and so forth.

In addition to notification features, the software program within the data processing resource 122 may also have instructions for placing automated service requests such as, for example, transmitting orders for replacement devices or replacement parts thereof, orders for refilling of depleted materials, requests for system configuration adjustments or upgrades, and so forth.

Additional features and benefits provide by a system according to system 100 may include, for example, system trend analysis, whereby historical data is aggregated and correlated to produce reports depicting performance, maintenance or status events over a given period of time.

While certain embodiments and features of the invention have been illustrated and described herein, many modifications, substitutions, changes, and equivalents will occur to those of ordinary skill in the art, and the appended claims cover all such modifications and changes as fall within the spirit of the invention.

We hereby claim:

1. A multi-water system, comprising:
a multi-water faucet having a plurality of input ports, an output port, and a selecting valve for selecting a water path from any among the plurality of input ports to the output port;
means for performing a given first filter operation on an external water and for outputting a resulting first processed water to a first of said plurality of input ports of said multi-water faucet; and
means for performing a given second filter operation on the external water and for outputting a resulting second processed water to a second of said plurality of input ports of said multi-water faucet.

2. The multi-water system of claim 1 wherein said means for performing a first filter operation includes a first filter unit having an input port for receiving the external water and having an output port, and includes a water path from said output port to said first of said plurality of faucet input ports.

3. The multi-water system of claim 2, wherein said second filter operation includes said first filter operation, and said means for performing a second filter operation includes said first filter unit and a second filter unit having a second filter input port, a first intermediate tap providing a water path from said first filter output to said first faucet input and a water path from said first filter output to said second filter input port.

4. The multi-water system of claim 1, further comprising means for selectively outputting a supplemented water from the output port of the multi-water faucet.

5. The multi-water system of claim 4, wherein said means for selectively outputting a supplemented water includes a flavor reservoir for holding a given flavoring, and a means for selectively introducing the flavoring into the water prior to being output from the output port of the multi-water faucet.

6. The multi-water system of claim 1, further comprising:
a data processor machine having a machine readable storage medium for storing machine readable instructions;
a sensor for detecting a water flow associated with at least one of said means for performing a given first filter operation and said means for performing a given first filter operation, and for generating a corresponding sensor signal; and
means for communicating said sensor signal to said data processor machine,
wherein machine readable instructions cause said data processor machine to monitor said sensor signal and to generate an alarm in response to a given condition of said sensor signal.

7. The multi-water system of claim 6, wherein said machine readable instructions cause said data processor machine generate a service request communication based on a given condition of said sensor signal.

8. The multi-water system of claim 1, further comprising a means for performing a given third filter operation on an external water and for outputting a resulting third processed water to a third of said plurality of input ports of said multi-water faucet, and
wherein said selecting valve includes a rotating valve member having a at least three discrete rotational positions, constructed and arranged wherein, at a first of the rotational positions, said selecting valve prevents water flow path from the first of the input ports and the second of the multi-water faucet to the output port of the multi-water faucet and forms a flow path from the third of the input ports of the multi-water faucet to the output port of the multi-water faucet,
wherein at a second of the rotational positions, said selecting valve prevents water flow path from the first and the third of the input ports of the multi-water faucet to the output port of the multi-water faucet and forms a flow path from the second of the input ports of the multi-water faucet to the output port of the multi-water faucet, and
wherein at a third of the rotational positions, said selecting valve prevents water flow path from the second and the third of the input ports of the multi-water faucet to the output port of the multi-water faucet and forms a flow path from the first of the input ports of the multi-water faucet to the output port of the multi-water faucet.

9. The multi-water system of claim 8 wherein said means for performing a first filter operation includes a first filter unit having an input port for receiving the external water and having an output port, and includes a water path from said output port to said first of said plurality of faucet input ports, and
wherein said second filter operation includes said first filter operation, and said means for performing a second filter operation includes said first filter unit and a second filter unit having a second filter input port, a first intermediate tap providing a water path from said first filter output to said first faucet input and a water path from said first filter output to said second filter input port.

10. The multi-water system of claim 9 wherein said wherein said third filter operation includes said second filter operation, and said means for performing a third filter operation includes said first filter unit, said second filter unit, and a third filter unit having a third filter input port, a second intermediate tap providing a water path from said second filter output to said second faucet input and a water path from said second filter output to said third filter input port.
